(19) United States
(12) Patent Application Publication
(10) Pub. No.: US 2009/0229476 A1
(43) Pub. Date: Sep. 17, 2009

(54) PORTABLE COOKING DEVICE

(76) Inventor: Mark Bedard, St. Lambert (CA)

Correspondence Address: MERCHANT & GOULD PC, P.O. BOX 2903, MINNEAPOLIS, MN, 55402-0903, US

(21) Appl. No.: 12/047,872

(22) Filed: Mar. 13, 2008

(51) Int. Cl. A47J 37/01

(52) U.S. Cl. 99/447

(57) ABSTRACT

A portable cooking device suitable for baking foods such as pizza. The device can include a base with a cover, a fan mounted circulate air within the device, and a thermoelectric device for powering the fan.

### TECHNICAL FIELD

The present disclosure relates generally to portable cooking devices and, more particularly, to a versatile, portable cooking device utilizing a fan assembly designed to provide hot air circulation therein.

### BACKGROUND

Portable cooking or heating devices typically comprise of a heat resistant container, a removable cover and at least one feature to facilitate handling. Such portable cooking devices employ various heating methods and can be used to cook or prepare foods such as soups, pastas, and meats.

One issue with current cooking devices is that there is not a simple to use, versatile, portable cooking device that works well for cooking popular foods that are typically baked in an oven (e.g., pizza). There are many situations where such a portable cooking device is desirable such as camping, traveling, and tailgating. Further, oven baked foods such as pizza have gained widespread acceptance across various cultures in many regions around the world. This has led to a common problem as there are many countries of the world where the residing population does not have access to an oven in which such foods are most often cooked. In many areas of the world food is cooked over an open heat source rather than within an oven. Therefore, an improved portable cooking device is desirable.

### SUMMARY

The present invention addresses the need to provide a portable cooking device that is able to efficiently and effectively cook foods that are most often cooked in ovens. In an embodiment of the present disclosure the device is configured to be heated via a lower surface. The device includes a fan therein mounted above the lower surface to circulate the air within the cooking device. However, it will be evident to those skilled in the art that the portable cooking device can be realized in many different embodiments to cook a variety of different foods.

### DESCRIPTION OF THE DRAWINGS

Reference is now made to the accompanying drawings illustrating a possible embodiment of the present invention.

FIG. 1 is a perspective view of a heating device according to one embodiment of the present invention;

FIG. 2 is an exploded view of the heating device of FIG. 1; and

FIG. 3 is a cross sectional view of the heating device of FIG. 1;

### DETAILED DESCRIPTION

According to one embodiment of the present disclosure, a heating device includes a pan, a cover for the pan, a fan mounted to the cover on an underside thereof and a thermoelectric device having a heat sink located on an underside of the cover and a cold sink located on a top side of the cover, the thermoelectric device being operatively connected to the fan.

According to another embodiment of the present disclosure, a heating device for cooking a pizza is provided including a pan having a bottom wall and a side wall, the side wall having a ledge formed thereon; a cover for the pan; a support member sized to fit on the ledge; and a ceramic stone designed to be mounted on the support member, the ceramic stone having a top surface and a bottom surface, the top surface being generally flat, the bottom surface having a centrally located portion with a concaved configuration.

The base of the present disclosure may be anything suitable to provide a cooking space; in some embodiments the base take the form of what is commonly known as a pot or a pan comprising a bottom wall and a side wall which together define an open space within the pan. The base of the device is conventionally formed of a metallic material, but can be made of any material capable of being heated by contact (e.g., an electric stove top) or flame. Additionally, the cover can be made of any material including glass, ceramic or combination of metals thereof. The cover may be insulated as well.

In one embodiment, the heating device includes a support member. The support member is designed to fit within the pan and support the cooking surface therein. The support may have means for supporting itself on the bottom wall.

In the embodiment wherein the assembly is utilized for heating pizza and the like (e.g., other baked foods), a baking stone is provided. A baking stone supports the food within the cooking device. Baking stone are used much like cookie sheets, but may absorb additional moisture for crispier food. Moreover, due to the thermal properties of the stone used, food is less likely to burn when using a baking stone than when using a cookie sheet.

In some embodiments, the baking stone is a pizza stone. In such embodiment, the stone has a generally planar upper surface for supporting a pizza. In some embodiment the stone is ceramic or earthenware used to evenly distribute oven heat to pizzas or other baked goods. In some embodiments, the thermal mass and porous nature of the stone helps absorb moisture, resulting in a crisp crust.

According to the depicted embodiments, a thermoelectric device is employed utilizing the Seebeck effect, which is the conversion of temperature differences into electricity. The thermoelectric device relies on a voltage being created in the presence of a temperature difference between two dissimilar metals or semiconductor materials contacting each other, which in turn causes a direct current to flow into the conductors when they form a complete loop.

The depicted embodiment includes a cover designed to fit over the open space within the container, the cover supports a structure which mounts the fan and the thermoelectric device for powering the fan and. In the depicted embodiment the thermoelectric device is mounted to the cover with the hot or heat sink being within the interior of the cover with the cold sink being exterior of the top of the cover. In this respect, the term “heat sink” and “cold sink” are used to indicate the relative temperature of the two sinks, which are structures for absorbing and dissipating heat. The cold sink is that which is at a lower temperature than the heat sink during operation of the thermoelectric device. In one embodiment, the cold sink is integral with the handle.

In another embodiment the cover will also preferably include additional electronics to provide means for lighting the interior of the pan. For example, there may be provided a plurality of light emitting diodes (herein LED's) which can be used to permit visual access to the interior of the pan. The LED's may be lit continuously or alternatively and an on/off switch means may be provided. In the depicted embodiment, the fan is mounted to the underside of the cover and powered by the thermoelectric device. As options, additional electronics may be employed to provide pan interior heat measuring capabilities such as a thermometer and/or a timer.

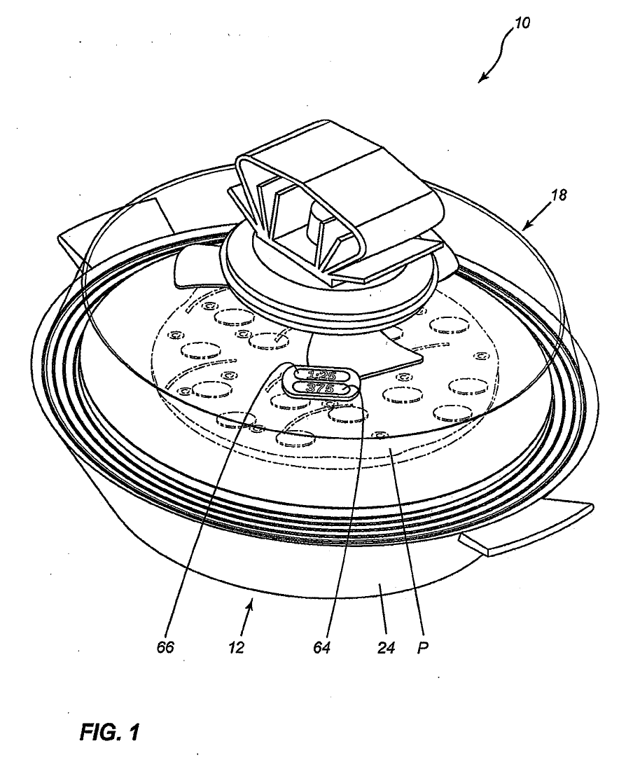

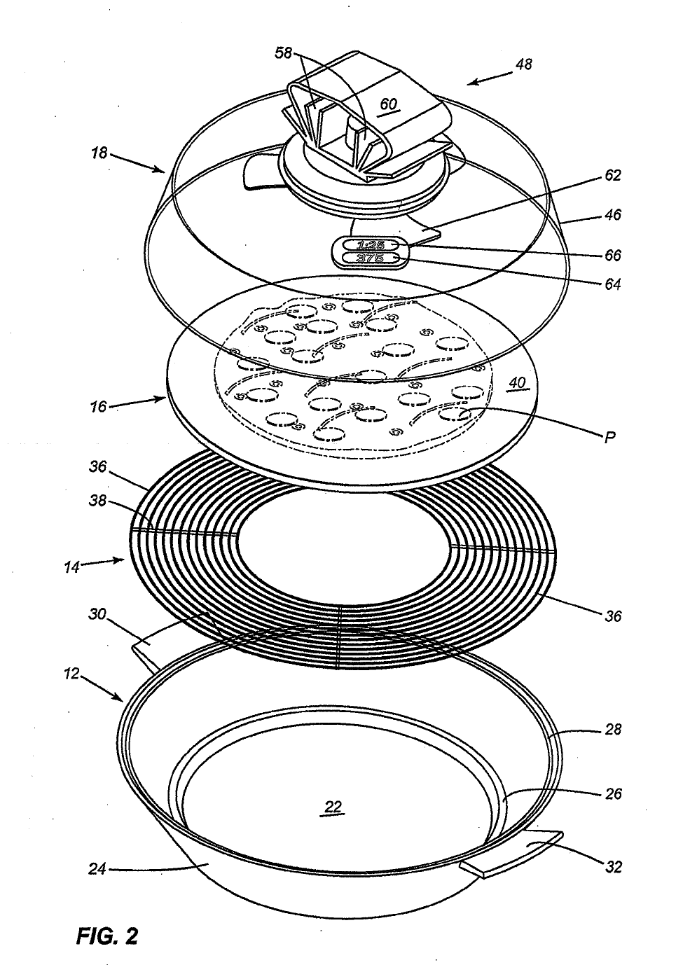

Referring to FIGS. 1-3 in greater detail and by reference characters thereto, there is illustrated a heating device which is generally designated by reference numeral 10. The heating device 10 comprises, in the illustrated embodiment, a pan 12, a support member 14, a stone 16 and a cover generally designated by reference numeral 18.

The pan 12 may be of any conventional material and configuration. In the illustrated embodiment, a pan is generally in a circular configuration and utilizes a bottom wall 22 and a side wall 24. In the depicted embodiment, the side wall 24 has a first ledge 26 located near the bottom wall 22 and a second ledge 28 near the upper extremity of side wall 24. A pair of handles 30 and 32 are diametrically opposed to each other. A support member 14, in the illustrated embodiment, is formed of a plurality of wires 36 which extend in a generally circular direction and cross members 38.

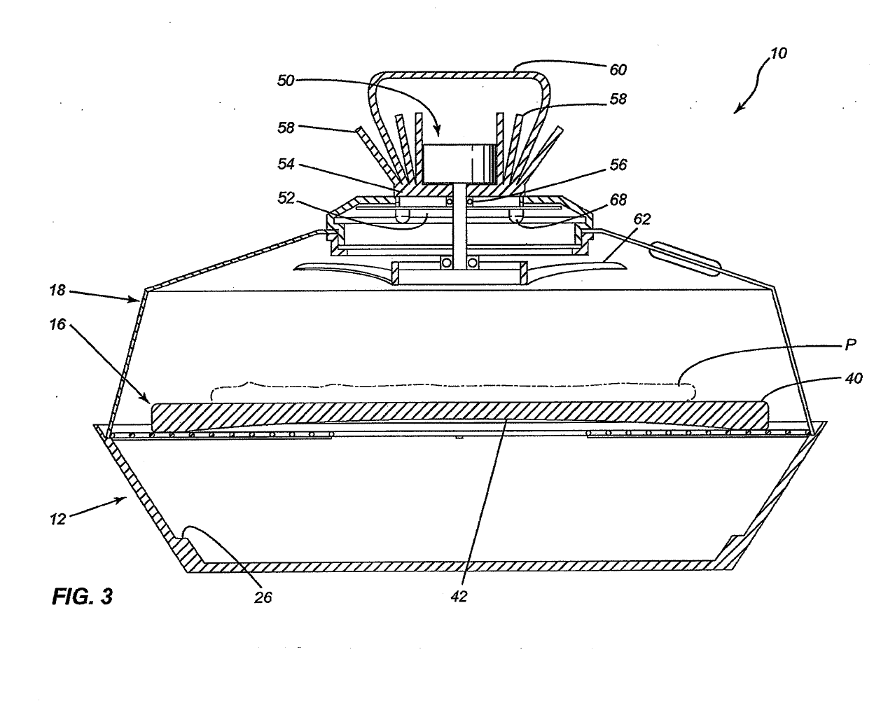

As above mentioned, a stone 16 may be provided which, as shown in FIG. 3, has a generally flat upper surface 40 and a lower concave surface 42. In this regard, a concave portion may extend substantially completely across the bottom or alternatively would only form a portion thereof at a point centrally located of the ceramic stone 16. An advantage of the concavity of lower surface 42 is that when the heating device is utilized to heat a pizza, a greater heat will be applied to the center. It should be noted that ceramic stone 16 is of a smaller diameter than support member 14 to enable heat to pass upwardly around side wall 24.

A cover 18 has a main body portion 46 which is preferably of a transparent material such as glass. A handle assembly generally designated by reference numeral 48 is located centrally of cover 18. Associated with handle assembly 48 is a thermoelectric device 50 which includes a hot sink 52 located at the underside of main body 60 and a cold sink 54 located at the upper side of main body 46. The thermoelectric device 50 also includes a generator 56.

Associated with handle assembly 48 and cold sink 50 are a plurality of fins 58 to assist in the dissipation of heat from cold sink 54. A handle 60 is included as part of handle assembly 48. Situated below main body 46 is a fan 62 which is powered by the thermoelectric device 50. In the illustrated embodiment, there is provided a temperature gauge 64 and a clock/timer 66 which will have suitable controls associated therewith (not shown). Further, as seen in the drawings, a pizza P is placed on the ceramic stone 16.

In operation of the heating device 10, the application of heat to bottom wall 22 of pan 12 will cause the heat to warm stone 16 and the upper portion of the container as it passes through the outer extremities of support member 14. This in turn will heat the hot sink 52 which will set up a temperature differential with the cold sink 54, thereby causing a flow of direct current electricity from a generator 56. The electricity thus generated can be used to operate fan 62 to cause a circulation of air similar to that in a convention oven. The power can also be utilized for temperature gauge 64, timer 66 and LED 68.

The preceding embodiments are intended to illustrate without limitation the utility and scope of the present disclosure. Those skilled in the art will readily recognize various modifications and changes that may be made to the embodiments described above without departing from the true spirit and scope of the disclosure.

We claim:

1. A cooking device comprising:
a base configured to receive heat from a heat source;
a cover configured to mate with the base to form a cooking space between the base and the cover; and
a fan positioned within the cooking space.

2. The cooking device of claim 1, further comprising a thermoelectric device having a heat sink located within the cooking space and a cold sink located outside of the cooking space, the thermoelectric device being electrically connected to the fan.

3. The cooking device of claim 1, further comprising a baking stone configured and arranged to provide a cooking surface within the cooking space.

4. The cooking device of claim 3, wherein said baking stone includes a ceramic construction and generally flat upper surface and a concaved bottom surface.

5. The cooking device of claim 3, further comprising a wire rack supporting the baking stone within the cooking space, wherein the wire rack is configured to be supported by the base.

6. The cooking device of claim 2, wherein the cold sink is mounted to the cover and configured to provide a handle for the cover.

7. The cooking device of claim 2, wherein said cold sink has a plurality of heat radiating surfaces.

8. The cooking device of claim 2, further comprising a plurality of LED lights electrically connected to the thermoelectric device and positioned to illuminate the cooking space.

9. The cooking device of claim 1, further comprising a timer mounted to the cover.

10. The cooking device of claim 1, further comprising a thermometer mounted on said cover.

11. A device for cooking a pizza comprising:
a base having a bottom surface configured to be placed over a heat source and a side wall that extends upward from the bottom surface;
a cover configured to mate with the side wall to form a generally enclosed cooking space;
a baking stone supported by the side wall above the bottom surface of the base, the baking stone having a top surface and a bottom surface, said top surface being generally flat, said bottom surface having a centrally located portion with a concaved profile; and a fan configured to circulate air within the cooking space.

12. The device of claim 11, wherein the bottom surface of said base is configured to receive heat from an open flame.

13. The device of claim 11, wherein said fan is powered by the heat source.

14. The device of claim 11, wherein said fan is powered by a thermoelectric device.

15. The device of claim 11, further including a timer mounted to the cover.

16. The device of claim 1, further including a temperature gauge mounted to the cover.

17. A method of baking food over a heat source comprising:
positioning a cooking device over a heat source;
providing food within the cooking device; and
circulating the air within the cooking device while the food therein cooks.

18. The method of claim 17, wherein the step of circulating the air includes providing a fan blade within the cooking device that rotates while the food therein cooks.

19. The method of claim 18, wherein the rotation of the blade occurs automatically based on the temperature within the cooking device.

20. The method of claim 19, wherein the blade is of an electric fan that is connected to a thermoelectric device.
